(19) United States
(12) Patent Application Publication
(10) Pub. No.: US 2006/0277110 A1
(43) Pub. Date: Dec. 7, 2006

(54) User interface for processing returns of pharmaceuticals

(76) Inventors: Brad Witter, Carmel, IN (US); Kyle Zeronik, Carmel, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/144,162

(22) Filed: Jun. 3, 2005

(51) Int. Cl. G06Q 30/00

(52) U.S. Cl. 705/26

(57) ABSTRACT

A system and method account for returned pharmaceuticals. In one embodiment, a user receives the pharmaceutical product and inputs a product identifier such as a national drug code (NDC) into the system. The system retrieves a list of possible packaging forms from a database, and the user selects the form that has been returned. The user enters a “handling quantity” of these packages, and the system determines the total quantity of pieces that were returned in terms of a certain predetermined unit. In some operational modes (based, for example, on a user's notation that the package has been opened), partial-unit entries can be made either in the form of an exact number of sub-units, or in the form of a percentage, sub-unit decimal, or fraction of the package that is full.

### FIELD OF THE INVENTION

The present invention relates to systems and methods for processing returns of pharmaceuticals. More specifically, the present invention relates to a data processing method that automatically converts unit quantities based on packaging types for accurate accounting of pharmaceutical returns.

### BACKGROUND

The invention relates generally to a computing system used by human operators to account for returns of pharmaceuticals. In existing systems, when a pharmaceutical recall is issued or expired product is returned, operators receive a package of returned merchandise and must enter into a database the type of product being returned, the quantity of product being returned, and the entity who returned it. The “quantity” datum is particularly difficult to deal with in the pharmaceutical area, where product can be packaged in multiple, nested “handling units,” such as a bottle of 50 tablets, where six bottles are in a box, 12 boxes are in a case, and four cases are in a crate, and goods may be returned in any of those types of packaging. Unlike retail goods, however, pharmaceuticals are not bar coded with universal product codes (UPCs) that indicate a level of nested packaging. Instead, pharmaceuticals bear “national drug codes” (NDCs) that specify only the retail package type (the “salable unit”). In existing pharmaceutical return processing systems, a particular unit (an “accounting unit”) was defined (typically by the manufacturer) for return accounting, and the operator had to mentally convert between the various forms of packaging and accounting units. The results were typically so inaccurate that sometimes retailers were credited up to 20 times the value of the product actually accounted for in the return system.

There is thus a need for further contributions and improvements to pharmaceutical return processing technology.

### SUMMARY

It is an object of the present invention to provide an improved system and method for collecting data regarding returned pharmaceuticals. It is another object of the present invention to enable persons to obtain more precise and accurate information regarding the quantity and character of pharmaceuticals being returned.

These objects and others are achieved by various forms of the present invention. One form of the present invention is a computer system having a user interface that the return processing technician uses to record information about returns that are received. The user interface accepts input of a product identifier, such as an NDC, then provides the user a list of valid package types for the identified product. The user interface then accepts user selection of a package type for the return and input of a quantity of those packages, and the system converts the quantity into predetermined units.

Another form is a method for processing returns of pharmaceuticals that includes inputting an identifier into a user interface. A list of package types associated with the product is retrieved, and the user selects one of them. The user enters a quantity of units being returned in terms of the selected package type, and an “accounting unit quantity” is calculated. In variations of this embodiment, the identifier is a national drug code, a receipt record is created for the product, and data entered and/or calculated is associated with a “disposition bin” that carries the product through the processing facility. Other variations obtain additional data input characterizing the returned product, and adjust the user interface and report accordingly. For example, some embodiments request and retain the lot number associated with the returned product or a status indicator for the integrity of the package that was returned. Some of these embodiments enter a special mode adapted for approximate entry and/or description of partial units.

Another form is a method for processing pharmaceutical returns that includes receiving input data from the user representing an identifier for a return product, receiving package type data that is either selected from a list of valid package types for that identifier or is validated against that data, receiving quantity information, and determining an accounting unit quantity for the return. Variations of this form determine the accounting unit quantity by applying a multiplicative factor to the entered package quantity, and some present accumulated return data for two or more processed returns. Some embodiments provide the user with a choice of packages for a given product, while others request and record expiration status (such as an expiration date or valid/expired status) during data entry. In some circumstances, the quantity information is restricted to integers or allowed to be a fraction or percentage depending on a packaging type and package integrity information, while in some embodiments, package quantities that exceed a threshold are rejected (or accepted only upon confirmation by the user). In some of these embodiments, the threshold is a function of package type and integrity.

### BRIEF DESCRIPTION OF THE DRAWINGS

FIG. 1 is a block diagram showing pharmaceutical distribution and return according to one embodiment of the present invention.

FIG. 2 is a block diagram of a computing system for use in one embodiment of the present invention.

FIG. 3 is a flow chart describing the method by which pharmaceutical returns are processed in the embodiment shown in FIG. 2.

FIGS. 4-11 are simulated screen shots of user input screens for use in the embodiment shown in FIG. 2.

### DESCRIPTION

For the purpose of promoting an understanding of the principles of the present invention, reference will now be made to the embodiment(s) illustrated in the drawings and specific language will be used to describe the same. It will, nevertheless, be understood that no limitation of the scope of the invention is thereby intended; any alterations and further modifications of the described or illustrated embodiment(s), and any further applications of the principles of the invention as illustrated therein are contemplated as would normally occur to one skilled in the art to which the invention relates.

Generally, one form of the present invention is a system and method for efficiently and accurately accounting for pharmaceutical returns that arrive for processing in a variety of nested types of packaging. The method involves accepting entry of a National Drug Code (NDC) by an operator, then adapting the data entry interface to allow selection and entry of options and values that are valid with respect to the identified product. For a given product, certain package types would not be appropriate, while other forms of packaging might be identifiable, but contain multiple units of another type.

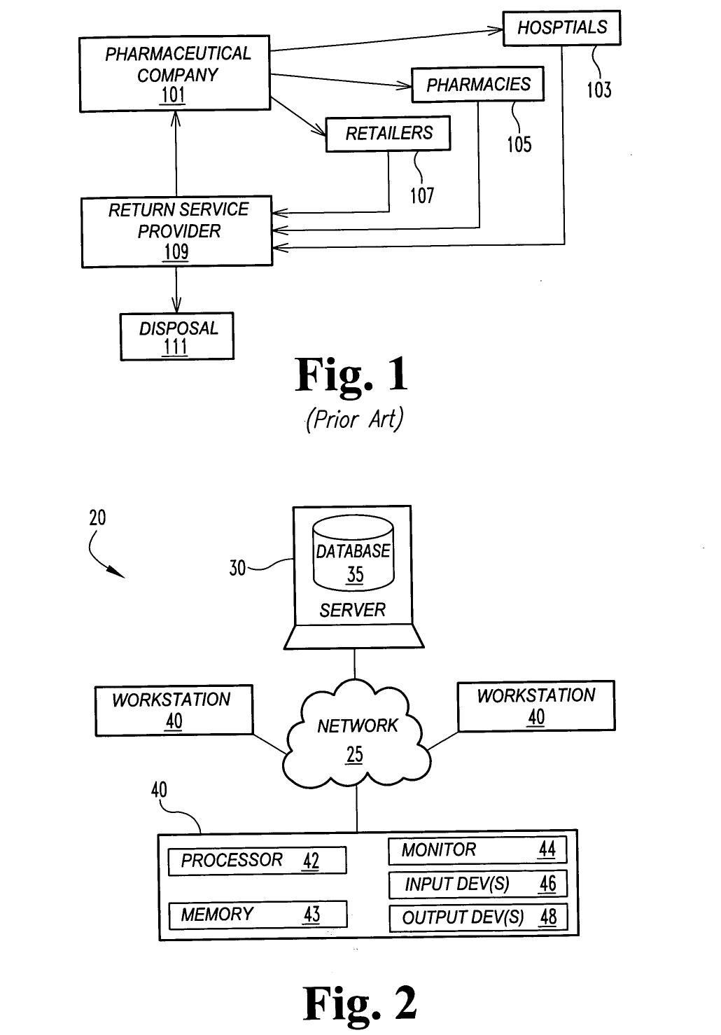

The context of this return processing is shown in FIG. 1 which is generally understood in the art. A pharmaceutical company 101 distributes its product to hospitals 103, pharmacies 105, and retailers 107. Expired product and drugs subject to recall are typically received from these entities by a company at a facility established for that purpose, return service provider 109. When the returns are accounted for at return service provider 109, unusable packages are disposed of via disposal facility 111, while resalable packages and refund accounting information are sent to pharmaceutical company 101. In some situations, wholesalers or other third parties (not shown) serve as intermediaries in the product distribution path, the product return path, or both.

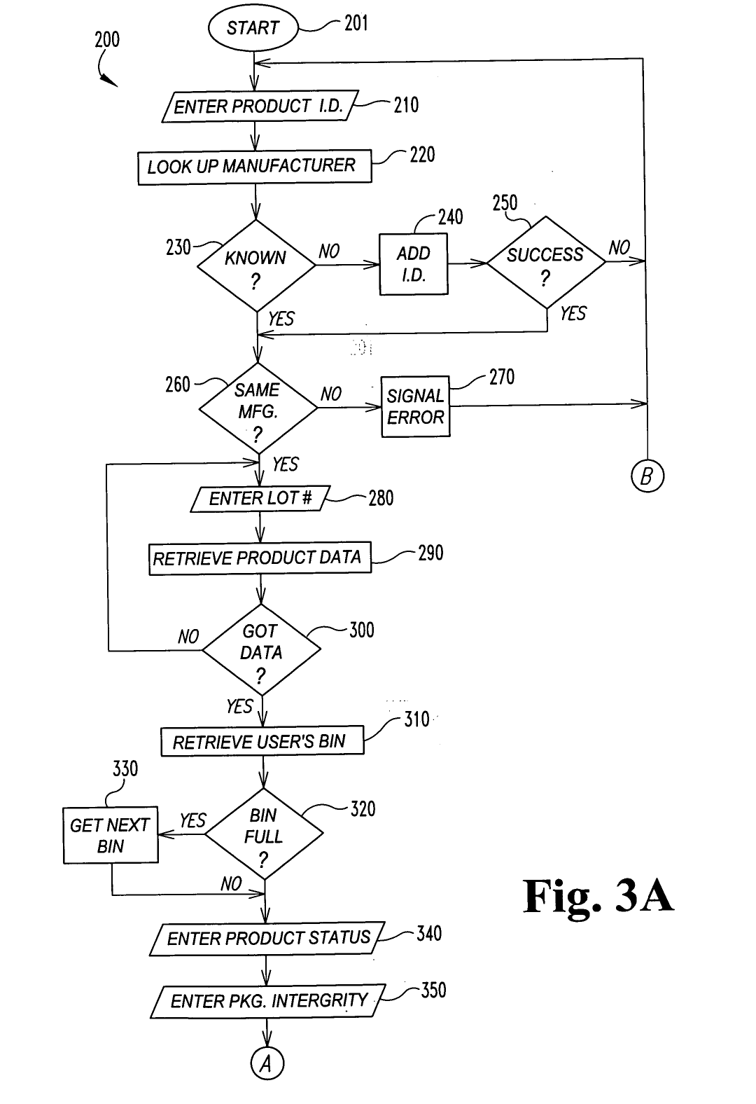

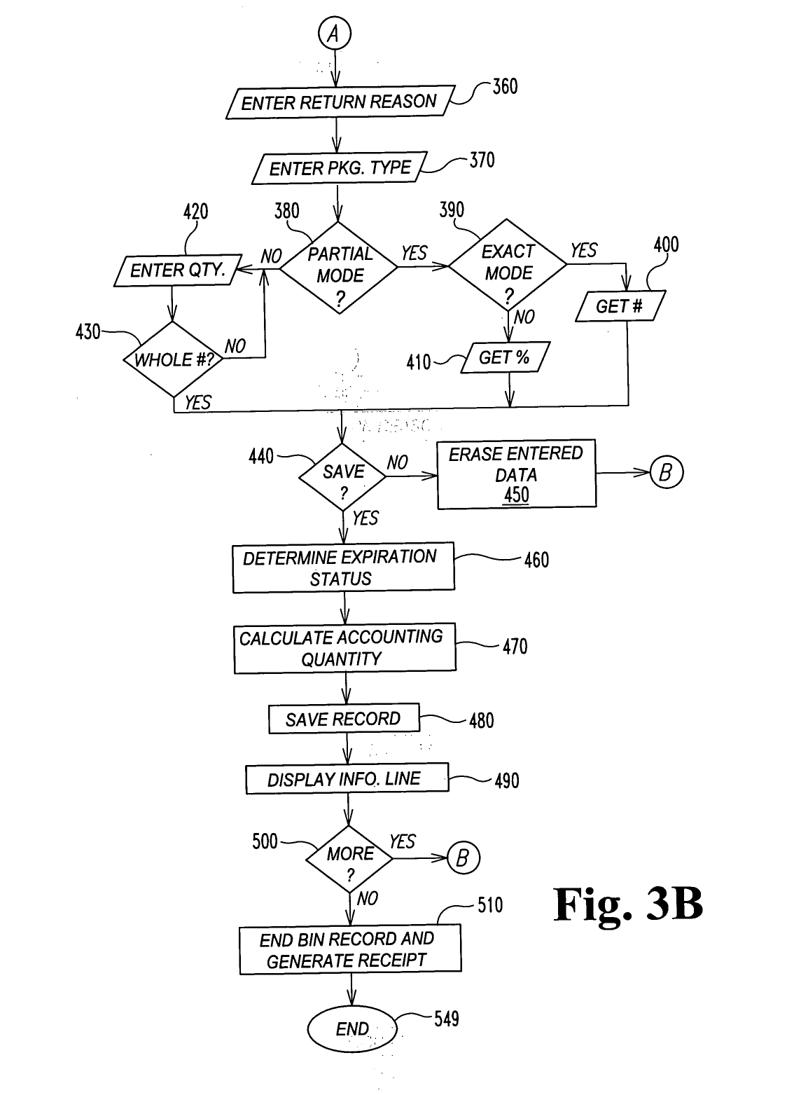

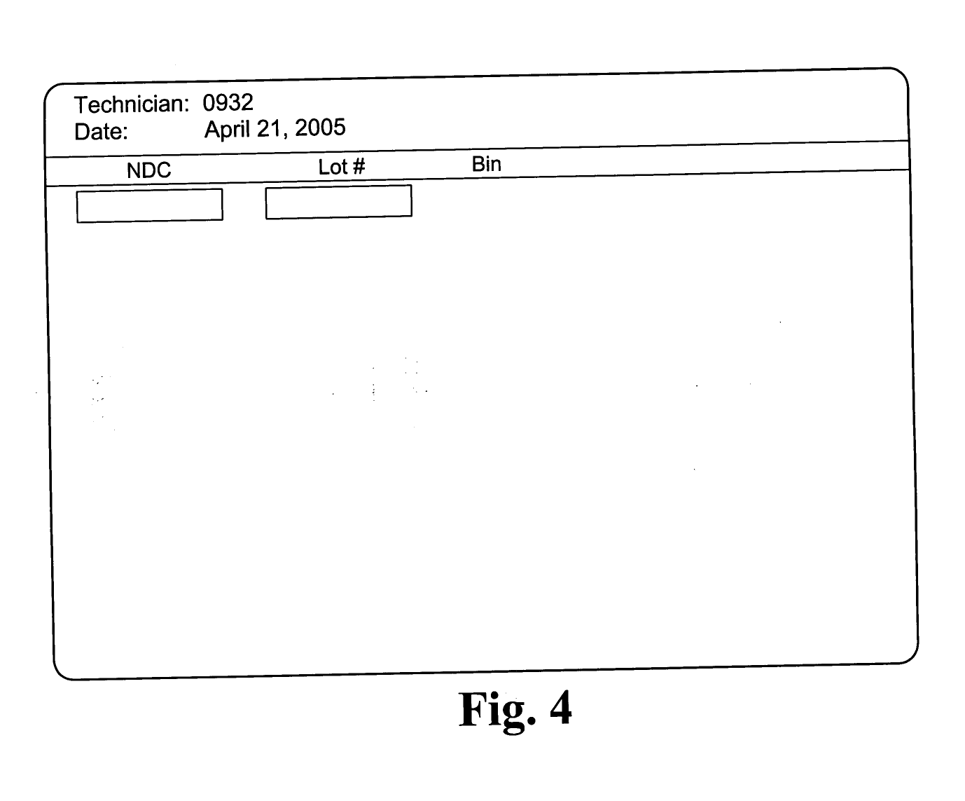

FIG. 2 is a block diagram of a computer network/system that includes a server housing a database, and several workstations used by operators for entering data characterizing returned products as will be discussed below. FIG. 3 is a flow chart of the processing steps that are undertaken at return service provider 109 in this example embodiment, which will now be discussed with reference to the screen shots in FIGS. 4-11 as well.

Turning to FIG. 2, system 20 includes components connected by network 25, which may be any suitable connecting means, such as a wire or wireless LAN, WAN, or other network as would occur to one skilled in the art. In this embodiment, server 30 houses database 35, while operators work at workstations 40 in various locations around the facility of return service provider 109 (as shown in FIG. 1). Workstations 40 may have the same or different configurations, but will generally include a processor 42, memory 43, monitor 44, input device(s) 46, and optional output device(s) 48.

Monitor 44 is a standard monitor device. It should also be appreciated that monitor 44 can be of a Cathode Ray Tube (CRT) type, Liquid Crystal Display (LCD) type, plasma type, Organic Light Emitting Diode (OLED) type, or such different type as would occur to those skilled in the art. Alternatively or additionally, one or more other output devices 48 can be utilized, such as a printer, one or more loudspeakers, headphones, or such different type as would occur to those skilled in the art.

Input device(s) 46 include an alphanumeric keyboard and mouse or other pointing device of a standard variety. Alternatively or additionally, one or more other input devices can be utilized, such as a bar code scanner, voice input subsystem, or another type of input device as would occur to those skilled in the art. Workstations 40 also include one or more communication interfaces (not shown) suitable for connection to a computer network, such as a Local Area Network (LAN), Municipal Area Network (MAN), and/or Wide Area Network (WAN) like the Internet. Processor 42 is designed to process signals and data associated with system 20 and generally includes circuitry, memory 43, and/or other standard operational components as is known in the art.

Processor 42 is of a programmable type; a dedicated, hardwired state machine; or a combination of these. Processor 42 performs in accordance with operating logic that can be defined by software programming instructions, firmware, dedicated hardware, a combination of these, or in a different manner as would occur to those skilled in the art. For a programmable form of processor 42, at least a portion of this operating logic can be defined by instructions stored in memory. Programming of processor 42 can be of a standard, static type; an adaptive type provided by neural networking, expert-assisted learning, fuzzy logic, or the like; or a combination of these.

As illustrated, memory 43 is integrated with processor 42. Alternatively, memory 43 can be separate from or at least partially included in processor 42. Memory 43 can be of a solid-state variety, electromagnetic variety, optical variety, or a combination of these forms. Furthermore, memory 43 can be volatile, nonvolatile, or a mixture of these types. Memory 43 can include a floppy disc, cartridge, or tape form of removable electromagnetic recording media; an optical disc, such as a CD or DVD type; an electrically reprogrammable solid-state type of nonvolatile memory; and/or such different variety as would occur to those skilled in the art. In still other embodiments, such devices are absent.

Processor 42 can be comprised of one or more components of any type suitable to operate as described herein. For a multiple-processing-unit form of processor 42, distributed, pipelined, and/or parallel processing can be utilized as appropriate. In one embodiment, processor 42 is provided in the form of one or more general purpose central processing units that interface with other components over a standard bus connection; and memory 43 includes dedicated memory circuitry integrated within processor 42, and one or more external memory components including a removable disk. Processor 42 can include one or more signal filters, limiters, oscillators, format converters (such as DACs or ADCs), power supplies, or other signal operators or conditioners as appropriate to operate system 20 in the manner described in greater detail herein.

Process 200 begins at START point 201, where an operator has received a returned pharmaceutical product. The operator enters an identifier for the product at block 210 on an input screen as shown in FIG. 4. In this embodiment, the product identifier is an NDC for the pharmaceutical being returned. Each product listed by the U.S. Food and Drug Administration is assigned a unique ten-digit, three-segment number known as the National Drug Code (NDC). The segments identify the “labeler” (vendor), the product, and the trade package size. The first segment is assigned by the FDA and identifies the firm that manufactures, repacks, or distributes the drug product. The second segment, the product code, is established by the labeler and identifies a specific strength, dosage form, and formulation for the product. The third segment, also assigned by the labeler, identifies the package size. The ten-digit NDC may be divided into these three segments in three ways: 4-4-2, 5-3-2, or 5-4-1 digits per segment. The FDA maintains listings of the meanings for each firm's codes.

When a product identifier has been entered, the system looks up the manufacturer associated with the product identifier at block 220. If the product identifier is unknown (a negative result at decision block 230), the system attempts to add the identifier at block 240 based on additional information from the operator. If this adding is not successful (a negative result at decision block 250), process 200 returns to input block 210 for entry of another product identifier. In some alternative embodiments, adding a new product identifier or lot number to the system is handled by input via another part of the system 20, independently of process 200.

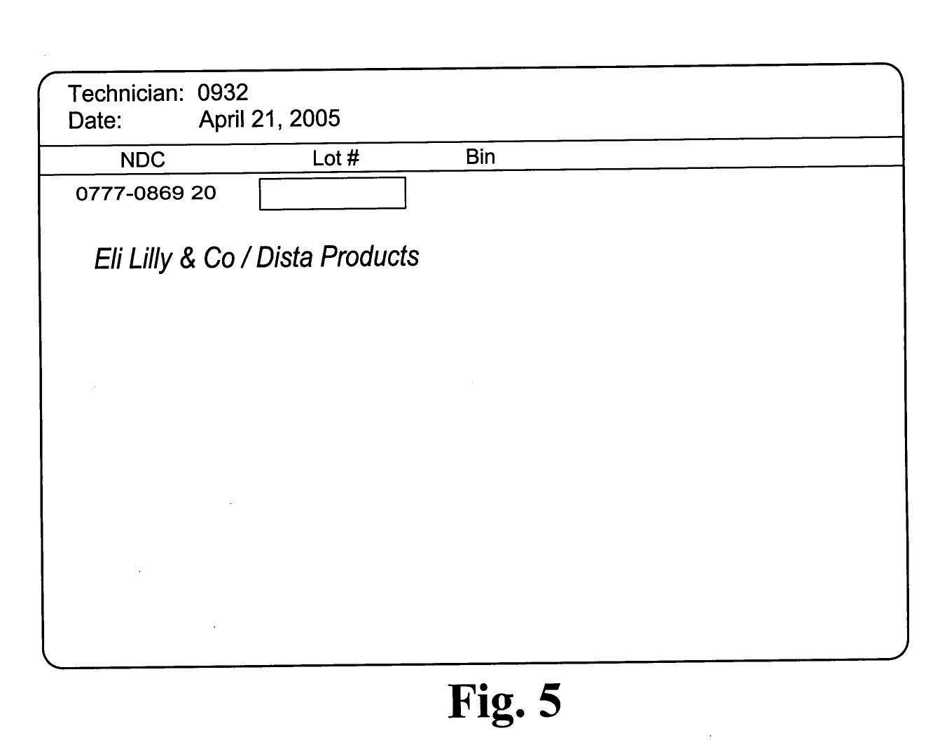

If the entered identifier is known (positive result at decision block 230) or a new identifier is successfully added (positive result at decision block 250), the system checks at decision block 260 whether the manufacturer associated with the identified product is the same as those previously entered for the current return batch. If not, an error is signaled at block 270, and process 200 returns for entry of the new product identifier at input block 210. If it is the same, or if no product has yet been processed for a particular batch, the system prompts the user to enter the lot number of the returned product at input block 280 (see FIG. 5). Then at block 290, the system retrieves information about the product based on the lot number, including (in this example) the trademark, dosage form, special status as a controlled, hazardous, or biological substance, manufacturer, expiration date, intended product disposition, recall status, and recall event number. If the system fails to retrieve this information (negative result at decision block 300), the user is again prompted to enter the lot number for the returned product at input block 280.

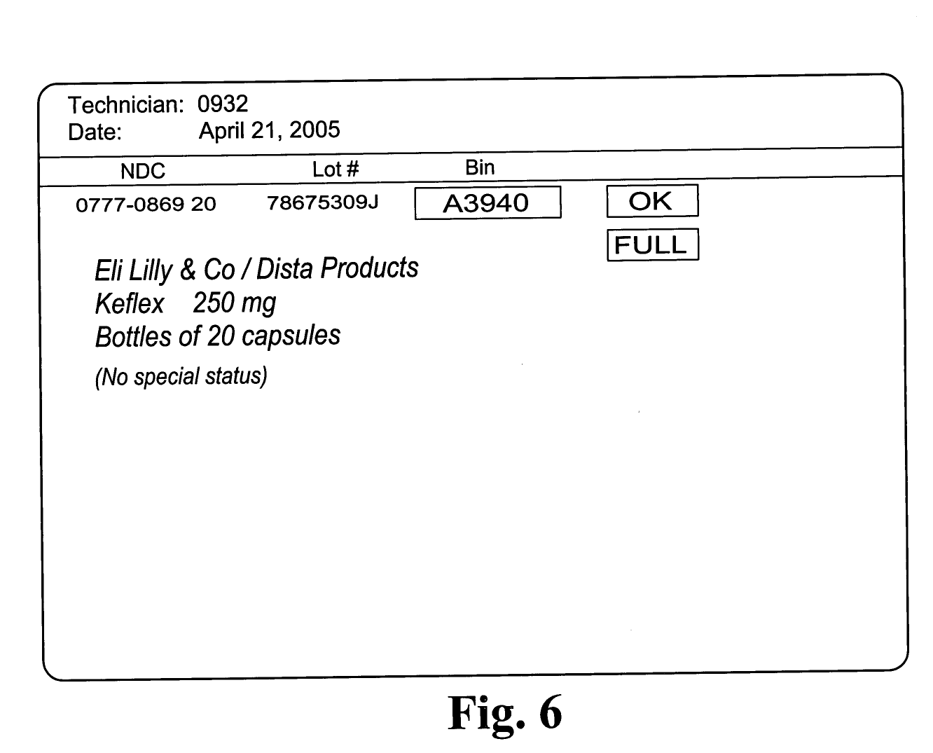

If the data retrieval was successful (positive result at decision block 300), the system displays selected portions of that data (see FIG. 6) and retrieves the user's current disposition bin identifier at block 310. If this bin is full (positive result at decision block 320), as noted by sensor, explicit user input (as by the “Full” button in FIG. 6), or other method that would occur to one skilled in the art, the system retrieves the next available bin at block 330 and closes the record for the full bin.

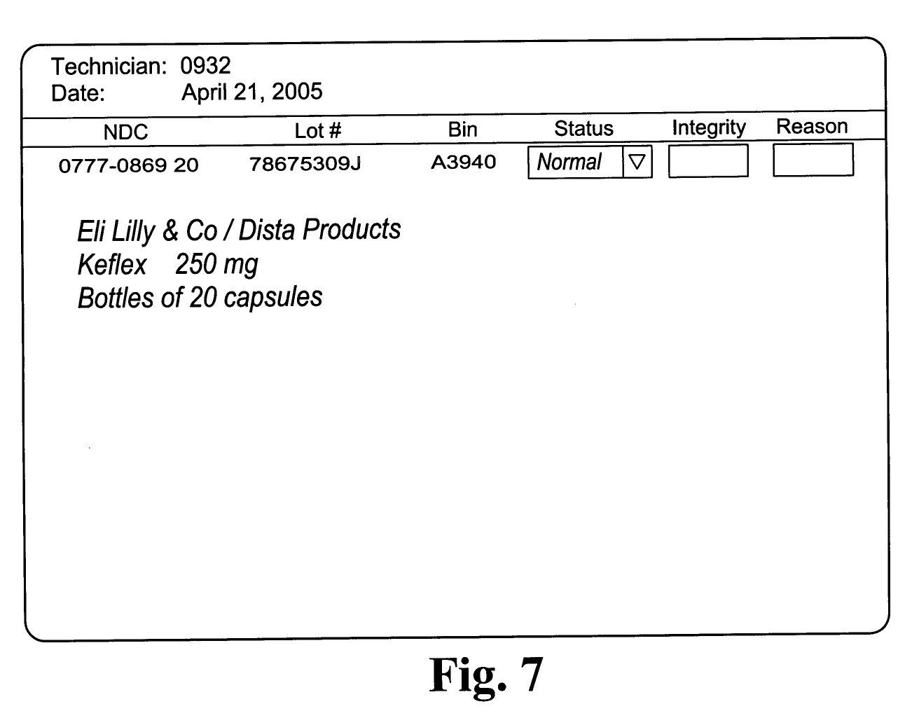

Once the disposition for the currently returned product is identified (either as a new bin at block 330 or an old bin with available space at block 320), the user enters the product status at input block 340. In this exemplary embodiment, the product status is selected from a predetermined list of available status codes that includes “normal,” “damaged,” “charred,” “defective,” “empty,” and “other” (see FIG. 7). The package integrity is then characterized by the operator at input block 350. In this embodiment, the package integrity status is selected from a predetermined list of codes that includes “normal,” “broken seal,” “crumpled,” “ripped,” “repackaged,” “soiled,” and “other.”

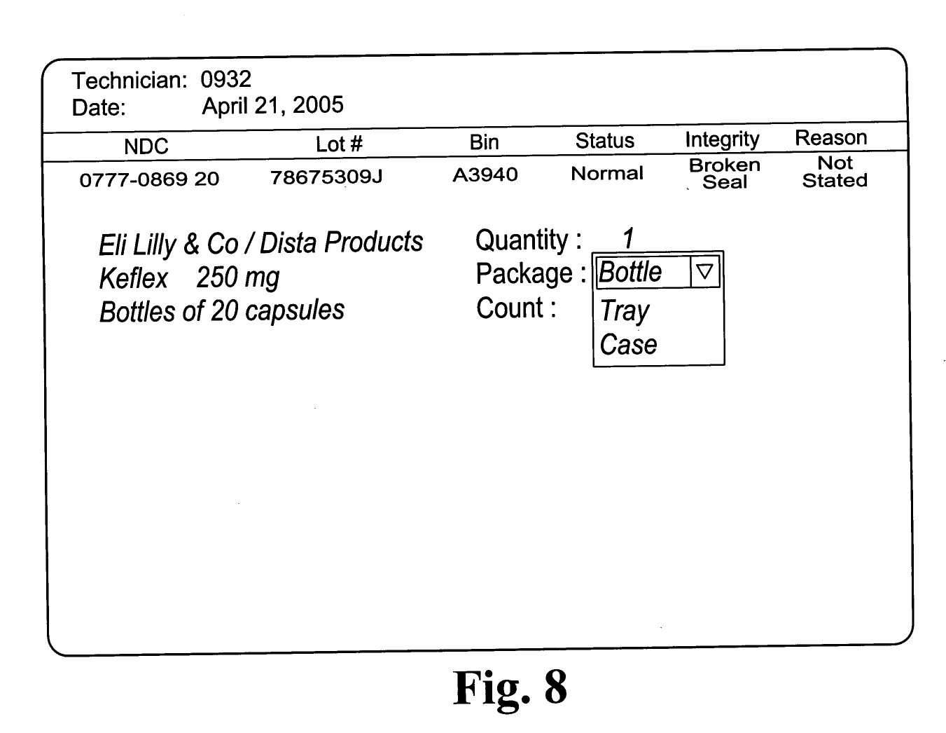

The system then accepts input by the operator of a reason for the return at block 360. In this example, the available “return reason” codes are predetermined, and are input based on information provided by the consignee of the returned pharmaceutical product. In this example, the available codes are “not stated,” “expired,” “short-dated,” “shipping error,” “overstocked,” “bankruptcy,” and “other.” Next, the operator enters the type of package that the return has at block 370 (see FIG. 8). In the present embodiment, the system only presents package types for selection that are valid given the product identifier, lot number, and other product data available at this point in process 200. In other embodiments, any package form on a global list may be selected here, but that selection is validated when the user attempts to save the return record.

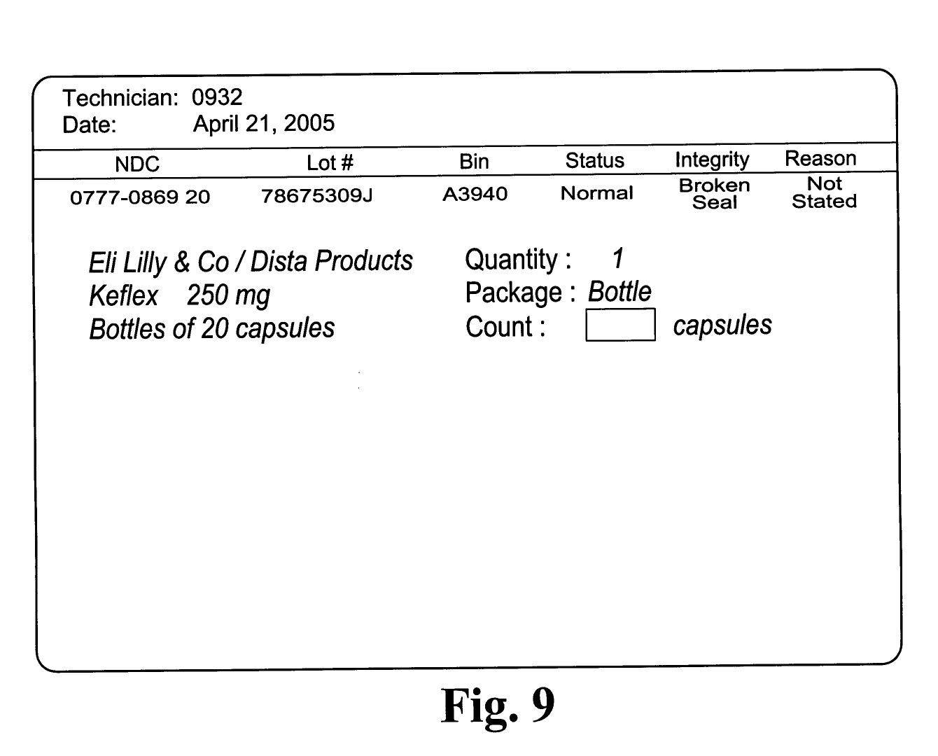

At decision block 380, the system determines whether a partial-unit input mode is appropriate. For example, if the package integrity code entered at input block 350 reflects that the unit had been opened, then the quantity is set to 1 (see FIG. 9), and the system determines at decision block 390 whether an exact or an estimate type of partial counting is appropriate. If the exact-type partial counting mode is determined to be appropriate, then the system takes input of the number of sub-units present at block 400 (again, see FIG. 9) and proceeds to decision block 440. If, instead, an estimate-type partial counting mode is appropriate (a negative result at decision block 390), the system takes input of a percentage value at block 410. In some embodiments, this input is limited to certain values, such as 25%, 50%, 75%, and 100%. In others, a free-form decimal, percentage, or fraction input field is provided. After completing input block 410, process 200 continues with decision block 440.

If the system determines (with a negative result at decision block 380) that a partial input mode is not appropriate, the system accepts entry of a quantity of packages (of the type identified at input block 370) at input block 420. The system tests at decision block 430 whether a whole number has been entered. If not, the system notifies the user of the error and returns for entry of a new quantity at input block 420. If a whole number was entered (a positive result at decision block 430), process 200 continues at decision block 430.

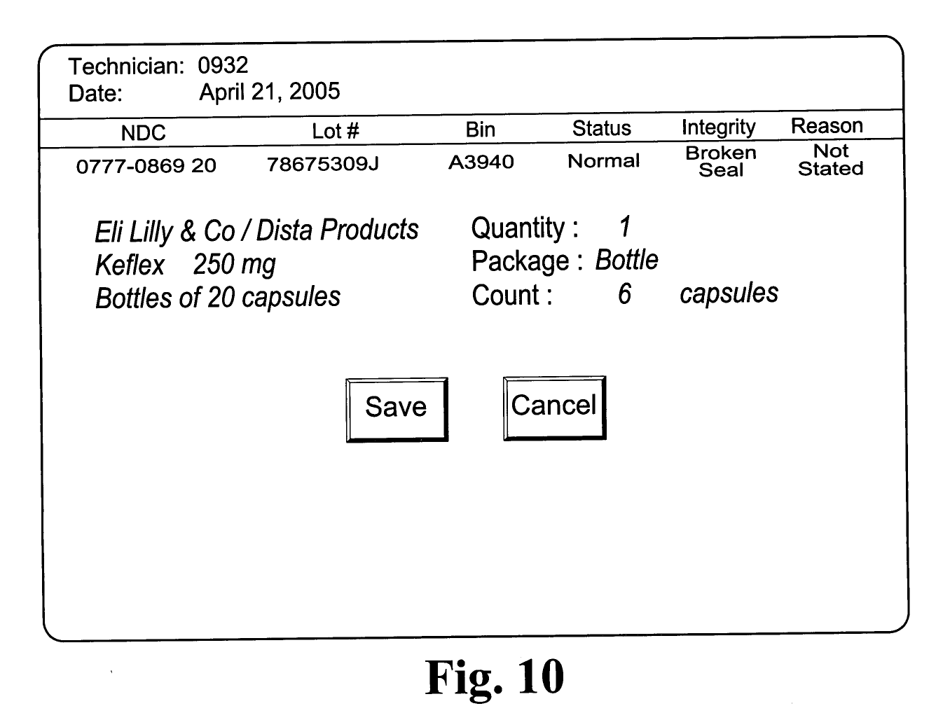

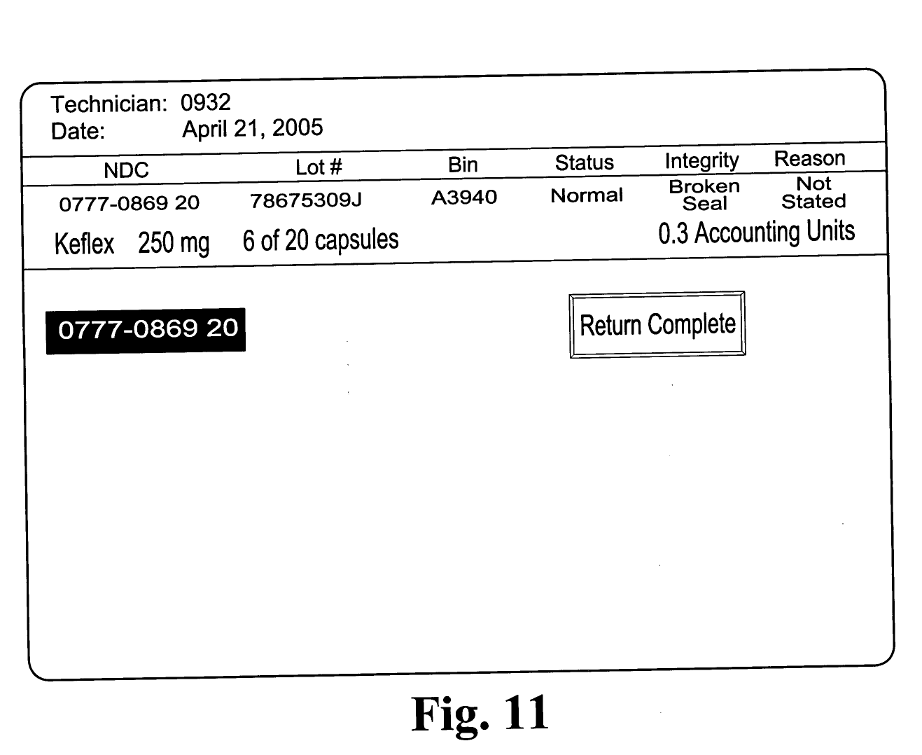

Decision block 440 reflects user input instructing the system either to save the data that has been input or discard it (see FIG. 10). If the user elects to discard the information (for example, using a “Cancel” button in the user interface, a negative result at decision block 440), then at block 450 the system erases the entered data and returns (via placeholder B) to input block 210 for entry of a new product identifier. If the user instructs the system to save the data (a positive result at decision block 440), the system determines the expiration status for the returned product at block 460 based on the current date and the expiration data retrieved at block 290. At block 470 the system calculates the quantity of product in terms of accounting units by applying appropriate factors and ratios to the quantity data given at block 400, 410, or 420, based on the package type and counting mode employed. The data record for the return is saved at block 480, and the information is displayed for review by the operator at block 490 (see FIG. 11). In this embodiment, the list of returns in a batch is maintained on the operator's screen until the return is finalized, allowing the user to cancel any line item and review the data entry before the return is completed. If there are too many entries to display on one screen, the system employs paging and/or scrolling to let the user access them all.

At decision block 500, the system determines whether there are more items in the return batch to be processed. This may be done, for example, based on explicit user input (e.g., using the “Returned Complete” button in FIG. 11), sensors in package handling equipment, or other way as would occur to one skilled in the art. If there are more items to be processed, the system returns (via placeholder B) for entry of another product identifier at input block 210. If the return batch is empty (a negative result at decision block 500), the system closes the disposition bin data entry, generates a receipt for the returned product, and completes other data commit, accounting, label printing, and other closing tasks as would occur to one skilled in the art at block 510. Process 200 stops at END point 549.

It should be appreciated that the various steps in process 200 can be performed at different locations, such as by different computers, as would occur to one skilled in the art. Additionally or alternatively, the steps described in connection with process 200 can all be performed at one computer or location. Likewise, many of the steps in process 200 can be reordered or even removed while keeping within the spirit of the present invention.

In some embodiments, a single operator processes a series of returns, while in others the operators work in parallel. In other embodiments, the data the operator enters is stored locally, while in still others the data is stored in a remote and/or distributed database.

In other embodiments, data that operators enter is confirmed by other operators or supervisors for accuracy, while in still others confirmation data is displayed to the operator during data entry.

In some embodiments, data is collected in a batch-style operation, while others persist data as each quantity is entered.

In some embodiments, operators are limited in their data entry to predetermined package types for each valid NDC, while others enable operators to use package types that had not been encountered before by the system, so long as the operator provides a counting relationship between the new package type and a package type already known to the system. In still others, a supervisor or other person must validate and/or approve new package types for a given NDC. Analogous options are available to system designers for the entry of new NDCs and manufacturers.

In some embodiments, at least a portion of the data input is achieved using bar code scanners and/or RFID tag readers. In variations on these embodiments, the NDC, manufacturer, lot number, package type, or any combination of these is communicated via bar code or RFID tag to the system, which fills the information into the data entry form and processes the remaining data for the return accordingly. The system may or may not require or request confirmation by the operator of data so entered. Any of these alternatives, along with others that will occur to those skilled in the art, would embody “input” of data as contemplated by the present disclosure.

In some embodiments, the manufacturer's identity is explicitly input by the operator, while in others it is inferred from the NDC, and in still others it is associated with the return bin from which the product was taken. In some of these embodiments, the manufacturer, NDC, package type, or other field is provided with a default value taken from a recent entry. In others, the data must be entered anew for each quantity being recorded.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for processing returns of pharmaceuticals, comprising: inputting an identifier that represents a returned pharmaceutical product into a user interface on a user's computer;
receiving a list of one or more package types associated with the identified product;
selecting one of the package types;
inputting a handling quantity of the product; and
generating a product information record characterizing the returned product, the information including an accounting unit quantity for the product.

2. The method of claim 1, wherein the identifier contains a national drug code.

3. The method of claim 1, wherein the identifier is linked in a database to a national drug code.

4. The method of claim 1, further comprising:
receiving data identifying an active disposition bin into which the user places the product; and
associating the active disposition bin with the product information record.

5. The method of claim 1, further comprising inputting a lot number associated with the product.

6. The method of claim 1, further comprising inputting a product status associated with the product.

7. The method of claim 1:
further comprising inputting a package integrity status; and
wherein a partial calculation mode is triggered by entry of one or more predetermined values for the package integrity status.

8. The method of claim 7, wherein the partial counting mode requires entry of an exact number of units.

9. The method of claim 7, wherein the partial counting mode limits data entry to a percentage representing a quantity of the product that is less than or equal to a single unit of the selected package type.

10. A method for processing returns of pharmaceutical products, comprising:
receiving input data from a user, via a user interface, representing an identifier for a returned product;
displaying, via the user interface, a list of one or more valid product package types associated with the product represented by the identifier;
accepting selection by the user, via the user interface, of a selected product package type;
receiving input data from the user, via the user interface, representing a handling quantity of the product in units of the selected product package type;
determining an accounting quantity of the product in terms of predetermined units as a function of the handling quantity and package type; and
presenting processed return data for the product to the user via the user interface, the processed return data including the accounting quantity of the product.

11. The method of claim 10, wherein the accounting quantity is determined by multiplying the handling quantity by an accounting unit conversion factor associated with the product identifier and selected package type.

12. The method of claim 10, further comprising presenting accumulated return data for two or more processed, returned products.

13. The method of claim 10, further comprising determining an expiration status associated with the product, wherein the processed return data further includes the expiration status.

14. The method of claim 10, wherein the handling quantity of the product is restricted to natural numbers.

15. The method of claim 10, further comprising requesting confirmation from the user when the input data received from the user representing the handling quantity of the product indicates a handling quantity greater than or equal to a predetermined threshold.

16. The method of claim 10, further comprising receiving additional input data from the user representing a lot number associated with the product.

17. The method of claim 16, further comprising adding the lot number to a system database.

18. The method of claim 10, wherein the identifier is a national drug code.

19. The method of claim 18, further comprising adding the national drug code received for the returned product to a system database.

20. The method of claim 10, further comprising determining a manufacturer of the product based on the identifier.

21. The method of claim 20, further comprising:
comparing the manufacturer of the product with one or more manufacturers of one or more previous return products; and
generating a continuity-of-manufacturers signal indicating the result of that comparison.

22. The method of claim 10, further comprising:
retrieving and presenting data identifying an active disposition bin for the product; and
presenting a confirmation to the user when the active disposition bin for the product is a new disposition bin.

23. The method of claim 10, further comprising receiving a first set of input data from the user characterizing the product, the first set of input data including a package integrity status associated with the product.

24. The method of claim 23, wherein a partial calculation mode is triggered by one or more predetermined conditions of the input data.

25. The method of claim 24, wherein one predetermined condition is that the handling quantity is one.

26. The method of claim 24, wherein one predetermined condition is that the package integrity status indicates that the package has been opened.

27. The method of claim 24, wherein one predetermined condition is that the package integrity status indicates a repackaged container.

28. The method of claim 24, further comprising receiving a quantity count of the product from the user to be used in determining the accounting unit quantity of the product, wherein an exact partial counting mode is associated with the product.

29. The method of claim 24, further comprising
receiving from the user a percentage value representing a quantity of the product; and
using the percentage value to determine the accounting unit quantity of the product; wherein an estimated partial counting mode is associated with the product.

30. A system, comprising a processor and a memory encoded with programming instructions executable by the processor to:
receive input from a user, the input including an identifier for a returned pharmaceutical product;
accept entry by the user of a product package type associated with the returned product;
receive input from the user including a handling quantity of the returned product;
determine an accounting unit quantity of the returned product as a function of the product package type and the handling quantity; and
present a set of processed return data associated with the return product, the processed return data including the accounting unit quantity of the return product.

31. The system of claim 30, wherein the accounting unit quantity is determined by multiplying the handling quantity by an accounting unit conversion factor associated with the product package type.

32. The system of claim 30, wherein the instructions are further executable by the processor to:
receive input from the user including a package integrity status associated with the returned product; and
when input is received that includes a package integrity status that indicates the possible return of a partial-unit quantity of the product, enter a partial-unit input mode.

33. The system of claim 32, wherein the program in partial-unit input mode receives input from the user including an exact count of the product in units smaller than the product package type.

34. The system of claim 32, wherein the program in partial-unit input mode receives input from the user including a percentage value representing a quantity of the product relative to a complete package.

35. A system, comprising a processor and a computer-readable medium encoded with programming instructions executable by the processor to:
receive an identifier, associated with a returned product, from a user,
present one or more product package types associated with the returned product identifiers,
receive a selection from the user of one of the one or more product package types,
receive data from the user representing a quantity of returned packages, and
calculate an accounting unit quantity of the returned product.

36. The system of claim 34, further comprising one or more parts of a computer network carrying one or more signals encoding the programming instructions.

37. The system of claim 34, the programming instructions being further executable by the processor to receive input from the user including a package integrity status, wherein under predetermined conditions the package integrity status triggers a partial counting mode.

38. The apparatus of claim 37, wherein:
the identifier is associated with a product form;
the product form is associated with an exact partial counting mode; and
the value representing a quantity of the returned product is an exact count of the return product in terms of units smaller than the selected product package type.

39. The apparatus of claim 37, wherein:
the identifier is associated with a product form;
the product form is associated with an estimated partial counting mode; and
the value representing a quantity of the returned product is a percentage that indicates how much of the selected product package type is full.

40. The apparatus of claim 39, wherein the product form is a liquid.
